(19) United States
(12) Patent Application Publication
(10) Pub. No.: US 2006/0129402 A1
(43) Pub. Date: Jun. 15, 2006

(54) Method for reading input character data to output a voice sound in real time in a portable terminal

(75) Inventor: Woong-Gyu Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/179,871

(22) Filed: Jul. 12, 2005

(30) Foreign Application Priority Data
Dec. 10, 2004 (KR) 2004-104197

(51) Int. Cl. G10L 13/08

(52) U.S. Cl. 704/260

(57) ABSTRACT

A method for reading input character data to output a voice sound in real time in a portable terminal. A character input is monitored, and a voice sound corresponding to input character data is output whenever the character input is performed in a preset minimum reading unit. A user can conveniently enter character data without the need for visual verification of the character data using a screen of a display unit.

### PRIORITY

This application claims priority to an application entitled “Method For Reading Input Character Data To Output A Voice Sound In Real Time In A Portable Terminal”, filed in the Korean Intellectual Property Office on Dec. 10, 2004 and assigned Serial No. 2004-104197, the entire contents of which are incorporated herein by reference.

### BACKGROUND OF THE INVENTION

1. Field of the Invention

The present invention relates generally to a portable terminal, and more particularly to a method for inputting character data.

2. Description of the Related Art

A portable terminal such as a mobile communication terminal, a personal digital assistant (PDA), etc. has functions which necessitate the input of character data. For example, the mobile communication terminal provides a multimedia message service, an E-mail service, an instant messenger service, etc. as well as a short message service (SMS) which necessitate the use of character data to edit, create, open, save and/or send messages. When a user of the mobile communication terminal creates or edits a text message and sends it using the message service, the user must enter character data of the text message into the mobile communication terminal.

A character input in the portable terminal is also required when a memo function or a phone book function is used. That is, when a memo is created or edited in the memo function, or when a phone number or personal name is registered, corrected or retrieved in a phone book function, a character input is required.

Portable terminals are adopting various character input methods according to their manufacturers or models. Before the portable terminal user becomes familiar with a character input method, the user enters character data while alternately confirming a screen of a display unit and a keypad because the user may erroneously enter character data. Accordingly, when the conventional character input methods are used, character input errors may frequently occur. Moreover, conventional character input methods can require a great deal of time to input character data.

### SUMMARY OF THE INVENTION

Therefore, it is an aspect of the present invention to provide a method that can conveniently provide input for the character data into a portable terminal.

It is another aspect of the present invention to provide a method that can reduce a time necessary to input character data.

The above and other aspects of the present invention can be accomplished by a method for reading input character data to output a voice sound in real time in a portable terminal. The method includes monitoring a character input; and outputting a voice sound corresponding to input character data whenever the character input is performed in a preset minimum reading unit.

Preferably, the minimum reading unit may be preset according to a character input method and language adopted in the portable terminal.

Preferably, voice data corresponding to the character data of the minimum reading unit may be retrieved from a voice data table, such that the retrieved voice data is reproduced to be output as the voice sound. Preferably, the character data of the minimum reading unit may be converted into the voice sound such that the voice sound is output, using a text-to-speech (TTS) function.

Preferably, when the character input is monitored, a grammatical error in the input of character data can be checked. When the grammatical error is detected, an error sound can be output such that a user is notified of the grammatical error.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a portable terminal in accordance with an embodiment of the present invention; and

FIG. 2 is a flow chart illustrating a procedure for reading input character data to output a voice sound in real time in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

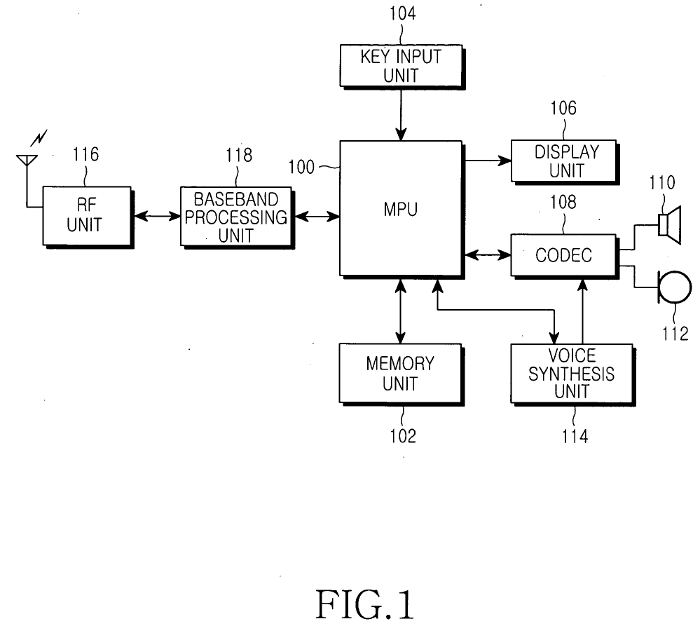

FIG. 1 is a block diagram illustrating a portable terminal which is an example of a conventional mobile phone to which the present invention is applied. A microprocessor unit (MPU) 100 performs a function for reading input character data to output a voice sound in real time in accordance with an embodiment of the present invention as well as various functions such as a telephone communication function, a data communication function, and a wireless Internet access function.

A memory unit 102 stores a voice data table as well as a program to be used for processing and control operations by the MPU 100, reference data, and various data capable of being updated. Further, the memory unit 102 provides a working memory of the MPU 100. The voice data table is a table in which voice data is mapped to language-by-language character codes. The voice data table is preferably stored in advance in the memory unit 102 by a manufacturer or mobile communication company.

A key input unit 104 includes numeric keys of “0” to “9”, “*” and “#” keys, and various function keys such as “Menu”, “Select”, “Send/Talk”, “Clear”, “Power/End”, and “Volume” keys provided in a corresponding mobile phone. The key input unit 104 provides the MPU 100 with key input data corresponding to a key pressed by the user. A display unit 106 displays a received image, an image stored in the memory unit 102, and/or an image containing various types of information which is provided from the MPU 100, on a screen according to a control operation of the MPU 100.

A coder-decoder (CODEC) 108 connected to the MPU 100, and a speaker 110, and a microphone 112 connected to the CODEC 108 are used for a telephone communication function, a voice recording function, and a function for reading input character data to output a voice sound in accordance with the embodiment of the present invention. A voice synthesis unit 114 performs voice synthesis according to voice data retrieved from the voice data table of the memory unit 102 through the MPU 100, and outputs a result of the voice synthesis to the CODEC 108.

A radio frequency (RF) unit 116 transmits an RF signal to and receives an RF signal from a mobile communication base station. The RF unit 116 modulates a signal to be transmitted from the MPU 100 through a baseband processing unit 118, and transmits an RF signal through an antenna. Further, the RF unit 116 demodulates an RF signal received through the antenna and provides the RF signal to the MPU 100 through the baseband processing unit 118. The baseband processing unit 118 processes a baseband signal transmitted and received between the RF unit 116 and the MPU 100.

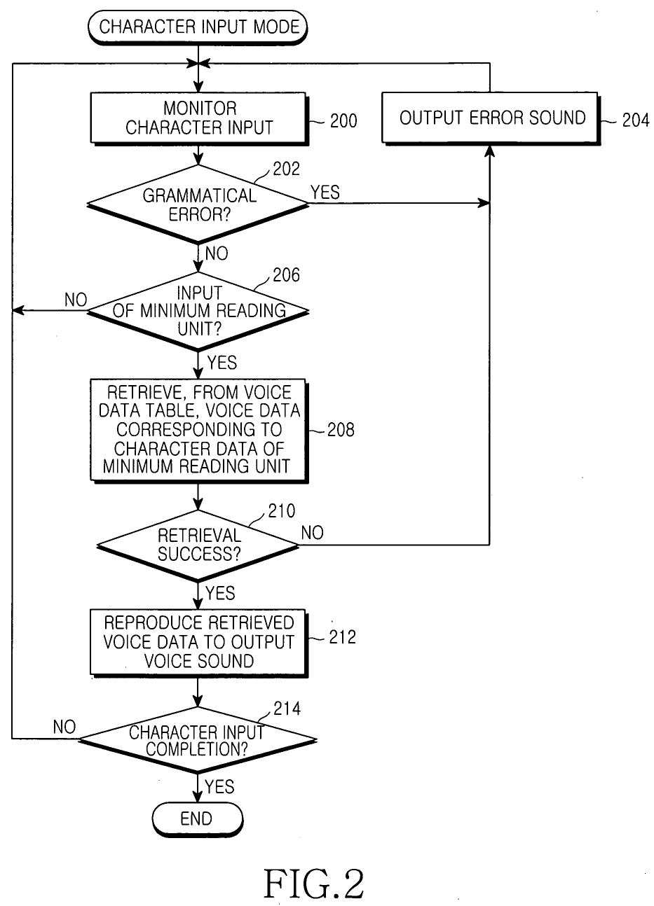

FIG. 2 is a flow chart illustrating a procedure for reading input character data to output a voice sound in real time in accordance with an embodiment of the present invention. The MPU 100 performs steps 200 to 214 in a character input mode. When a text message function, a memo function or a phone book function are used, the character input mode is selected by the user to input character data. In other words, when the text message function, the memo function or the phone book function is selected by the user, and the user selects a menu which requires a character input, then the character input mode is automatically selected. For example, if the user selects a message creation menu in a text message function, the corresponding character input mode is automatically selected.

When the user conventionally selects the character input mode, the MPU 100 receives character data input from the user through the key input unit 104, and displays the received character data on a screen of the display unit 106.

The MPU 100 monitors the character input in step 200, checks for one or more grammatical errors in step 202, and determines if character data has been input in a minimum reading unit (which will be described below). The input character data is checked in real time using a conventional grammatical error diagnosis algorithm in step 202. When the input character data of the user contains a grammatical error, an error sound is output through the speaker 110 in step 204 and then the character input is continuously monitored in step 200. For example, the spelling of “lo ve” would be recognized as a grammatical error and can cause an error sound to be output by the speaker 110.

If it is determined that character data has not been input in the minimum reading unit in step 206, the character input is continuously monitored in step 200. However, if it is determined that character data has been input in the minimum reading unit in step 206, step 208 is performed. The minimum reading unit is a minimum unit for making a voice sound according to the user's character input. The minimum reading unit is preset according to a character input method and language adopted in the portable terminal. For example, one syllable or one word can be set as the minimum reading unit. More specifically, the minimum reading unit in the case of the English language can be set to one word before a space is entered.

In step 208, voice data corresponding to the character data of the minimum reading unit is retrieved from the voice data table of the memory unit 102. If it is determined that the retrieval is successful in step 210, the retrieved voice data is synthesized by the voice synthesis unit 114, and a voice sound thereof is reproduced by the speaker 110 through the CODEC 108 in step 212. As described above, character data input by the user is read and a voice sound thereof is output.

However, if the retrieval fails in step 210, that is, if the voice data corresponding to character data of the minimum reading unit is absent or corrupted in the voice data table, an error sound is output through the speaker 110 in step 204, and then the character input is monitored in step 200. For example, when a misspelled word such as “baceball”, etc. is input, its voice data is absent in the voice data table and, therefore, cannot be reproduced and an error sound is subsequently output.

Accordingly, when using a function necessary to enter character data, the user can enter the character data without the need for visual verification of the character data using a screen of the display unit because the entered character data is read and then a voice sound thereof is output. Therefore, any user unfamiliar with a character input method can conveniently enter character data, the time period taken to enter the character data can be reduced, and character input errors can be minimized or entirely eliminated.

Although preferred embodiments of the present invention have been disclosed for illustrative purposes, those skilled in the art will appreciate that various modifications, additions and substitutions are possible, without departing from the scope of the present invention.

An example of using a voice data table for outputting a voice sound of input character data has been described in the embodiment of the present invention. Moreover, the present invention can adopt a TTS function to convert input character data into a voice sound and output the voice sound. The character data can include a number and a special symbol. As voice data is mapped to the number and special symbol in the voice data table, input character data can be read and a voice sound thereof can be output.

Further, an example of applying the present invention to a mobile phone has been described. Moreover, the present invention can be applied to any portable terminal (e.g., a personal digital assistant (PDA, a cellphone, etc.).

Therefore, the present invention is not limited to the above-described embodiments, but is defined by the following claims, along with their full scope of equivalents.

What is claimed is:

1. A method for reading input character data to output a voice sound in real time in a portable terminal, comprising:
monitoring a character input; and
outputting a voice sound corresponding to the input character data when character input is performed in a preset minimum reading unit.

2. The method according to claim 1, wherein the minimum reading unit is preset according to a character input method and language adopted in the portable terminal.

3. The method according to claim 2, wherein the minimum reading unit is a syllable or a word.

4. The method according to claim 1, wherein outputting the voice sound step comprises:
retrieving voice data corresponding to the character data of the minimum reading unit from a voice data table stored in the portable terminal, the voice data table including language-by-language character codes and voice data mapped thereto; and
reproducing the retrieved voice data to output the voice sound through a speaker.

5. The method according to claim 1, wherein outputting the voice sound step comprises:
converting the character data of the minimum reading unit into the voice sound to output the voice sound using a text-to-speech (TTS) function.

6. The method according to claim 1, wherein the monitoring step comprises:
checking for a grammatical error in the input character data; and
outputting an error sound if a grammatical error is detected.
